(19) United States
(12) Patent Application Publication
(10) Pub. No.: US 2023/0202463 A1
(43) Pub. Date: Jun. 29, 2023

(54) VEHICLE TRANSPORT DEVICE, VEHICLE TRANSPORT METHOD AND VEHICLE TRANSPORT SYSTEM

(71) Applicant: TOYOTA JIDOSHA KABUSHIKI KAISHA, Aichi-ken (JP)

(72) Inventors: Masayuki ITOH, Nagoya-shi (JP); Iwao MAEDA, Nagoya-shi (JP); Tatsuya SUGANO, Susono-shi (JP); Norinao WATANABE, Susono-shi (JP); Yutaka NAKAMURA, Susono-shi (JP); Yoshikazu JIKUHARA, Susono-shi (JP); Yuki NISHIKAWA, Susono-shi (JP)

(21) Appl. No.: 18/146,381

(22) Filed: Dec. 25, 2022

(30) Foreign Application Priority Data
Dec. 28, 2021 (JP) 2021-215152

(51) Int. Cl. B60W 30/06; B60W 60/00

(52) U.S. Cl. CPC B60W 30/06; B60W 60/001; B60W 2300/12

(57) ABSTRACT

A vehicle transport device includes a traction portion having a drive wheel; a carriage portion coupled to the traction portion and supporting a transport object; and a controller configured to control travel of the vehicle transport device so as to selectively transport a four-wheeled vehicle and a personal transporter as the transport object.

### FIELD

The present disclosure relates to a vehicle transport device, a vehicle transport method and a vehicle transport system.

### BACKGROUND

A vehicle transport device for transporting vehicles for purposes such as automated valley parking is known in the art. The use of such a vehicle transport device makes it possible to reduce the troublesome tasks involved in parking.

### CITATIONS LIST

### Patent Literature

[PTL 1] U.S. Pat. No. 10,590,669

### SUMMARY

### Technical Problem

However, the vehicle to be transported does not always exist in the area where the vehicle transport device is dispatched. Therefore, there is a possibility that the vehicle transport device cannot be used effectively due to the increased waiting time of the vehicle transport device.

In view of the above problems, it is an object of the present disclosure to increase the operation rate of a vehicle transport device for transporting a vehicle.

### Solution to Problem

The summary of the present disclosure is as follows.

(1) A vehicle transport device comprising: a traction portion having a drive wheel; a carriage portion coupled to the traction portion and supporting a transport object; and a controller configured to control travel of the vehicle transport device so as to selectively transport a four-wheeled vehicle and a personal transporter as the transport object.

(2) The vehicle transport device described in above (1), wherein the carriage portion has a support plate configured to support a four-wheeled vehicle and a personal transporter.

(3) The vehicle transport device described in above (1), wherein the carriage portion includes a first carriage portion configured to support a four-wheeled vehicle and a second carriage portion configured to support a personal transporter, and the traction portion is selectively coupled to the first carriage portion and the second carriage portion.

(4) The vehicle transport device described in above (1), wherein the carriage portion has a vehicle support portion configured to support a four-wheeled vehicle, and a detachable portion that is detachable from the vehicle support portion and is configured to support a personal transporter.

(5) The vehicle transport device described in any one of above (1) to (4), wherein the controller is configured to control travel of the vehicle transport device so that the vehicle transport device transports a four-wheeled vehicle when transport of a four-wheeled vehicle is requested, and control travel of the vehicle transport device so that the vehicle transport device transports a personal transporter when transport of a four-wheeled vehicle is not requested.

(6) The vehicle transport device described in any one of above (1) to (5), wherein a power transmission device for supplying power to a personal transporter is provided in the carriage portion, and the controller is configured to supply power to the personal transporter from the power transmission device when the vehicle transport device is transporting the personal transporter.

(7) A vehicle transport method comprising selectively transporting a four-wheeled vehicle and a personal transporter using a self-propelled vehicle transport device.

(8) A vehicle transport system comprising: a server; and a plurality of vehicle transport devices configured to communicate with the server, wherein each of the plurality of vehicle transport devices is configured to selectively transport a four-wheeled vehicle and a personal transporter in response an instruction from the server.

According to the present disclosure, it is possible to increase the operation rate of a vehicle transport device for transporting a vehicle.

### BRIEF DESCRIPTION OF DRAWINGS

FIG. 1 is a schematic configuration diagram of a vehicle transport system according to a first embodiment of the present disclosure.

FIG. 2 is a side view of a vehicle transport device according to the first embodiment of the present disclosure.

FIG. 3 is a top view of a vehicle transport device according to the first embodiment of the present disclosure.

FIG. 4 is a diagram schematically showing an electric configuration of a vehicle-transport device according to the first embodiment of the present disclosure.

FIG. 5 is a diagram schematically showing a configuration of a server.

FIG. 6 is a diagram showing an example situation in which a vehicle transport service is provided.

FIG. 7 is a diagram schematically illustrating a vehicle supported by a carriage portion of a vehicle transport device in an entry space.

FIG. 8 is a diagram schematically illustrating a vehicle transport device transporting personal transporters.

FIG. 9 is a flowchart illustrating a control routine executed in a server.

FIG. 10 is a flow chart showing the control routine executed in the vehicle transport device.

FIG. 11A is a side view of a vehicle transport device having a first carriage portion.

FIG. 11B is another side view of the vehicle transport device having the first carriage portion.

FIG. 12A is a top view of the vehicle transport device having the first carriage portion.

FIG. 12B is another top view of the vehicle transport device having the first carriage portion.

FIG. 13 is a diagram schematically illustrating a vehicle transport device having a second carriage portion.

FIG. 14 is a top view of a vehicle transport device in which a detachable portion is removed.

FIG. 15 is a top view of a vehicle transport device in which the detachable portion is mounted.

FIG. 16 is a diagram schematically showing an electric configuration of a vehicle transport device according to a fourth embodiment of the present disclosure.

### DESCRIPTION OF EMBODIMENTS

Hereinafter, embodiments of the present disclosure will be described in detail with reference to the drawings. In the following description, like components are denoted by the same reference numerals.

### First Embodiment

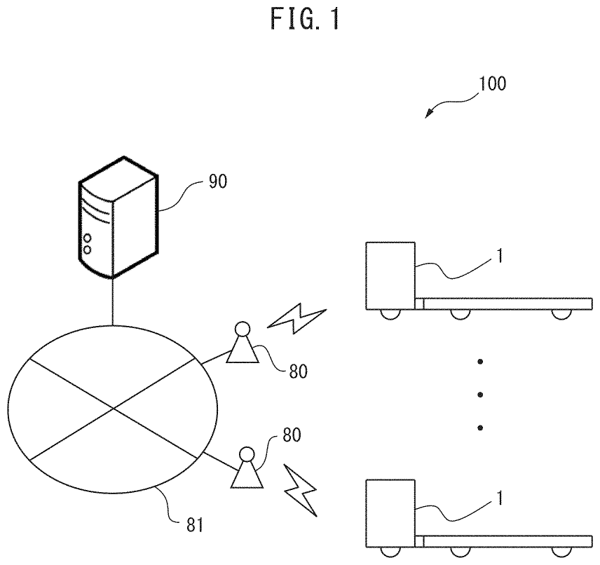

First, a first embodiment of the present disclosure will be described with reference to FIGS. 1 to 10. FIG. 1 is a schematic configuration diagram of a vehicle transport system 100 according to a first embodiment of the present disclosure. As shown in FIG. 1, the vehicle transport system 100 includes a plurality of vehicle transport devices 1 and a server 90. The server 90 is configured to communicate with each of the plurality of vehicle-carrying devices 1 via radio base stations 80, such as macrocells or small cells, and a communication network 81, such as an Internet-based network or a carrier network.

The vehicle transport system 100 provides a vehicle transport service using the vehicle transport device 1. Specifically, the vehicle transport system 100 transports a user's vehicle using the vehicle transport device 1 in response to a transport request from the user.

Vehicle transport device 1 transports a vehicle by traveling on the road while supporting the vehicle. In particular, in the present embodiment, the vehicle transport device 1 transports the vehicle by autonomous driving. That is, the vehicle transport device 1 is a self-propelled vehicle transport device.

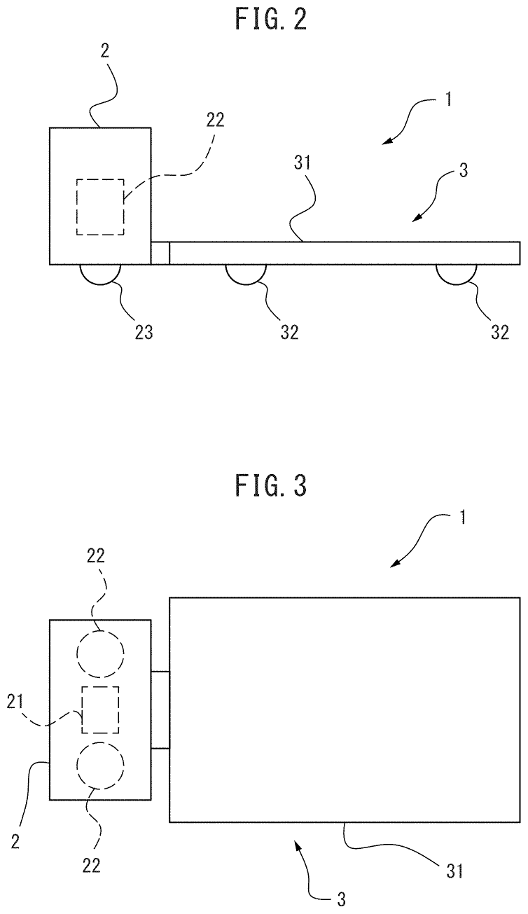

Hereinafter, the configuration of the vehicle transport device 1 will be described. FIG. 2 is a side view of the vehicle transport device 1 according to the first embodiment of the present disclosure, and FIG. 3 is a top view of the vehicle transport device 1 according to the first embodiment of the present disclosure. As shown in FIGS. 2 and 3, the vehicle transport device 1 has a traction portion 2 and a carriage portion 3 coupled to the traction portion 2.

The carriage portion 2 has a drive device, a drive wheel driven by the drive device, and a battery 21 which supplies power to the drive device. In the present embodiment, two drive motors 22 are provided in the traction portion 2 as a drive device, and two wheels 23 are provided in the traction portion 2 as drive wheels. The two drive motors 22 are driven by the power supplied from the battery 21 to rotate the two wheels 23. That is, the two drive motors 22 output the power for traveling of the vehicle transport device 1.

The carriage portion 3 supports the transported object, that is, the vehicle to be transported by the vehicle transport device 1. The carriage portion 3 has a support plate 31 and a non-driving wheel. In the present embodiment, as a non-driving wheel, four wheels 32 are provided on the carriage portion 3.

The support plate 31 has a thin plate shape, and has a flat support surface on which the transported object is placed. The support plate 31 extends horizontally and holds the transported object horizontally.

The traction portion 2 tows the carriage portion 3 together with the transported object supported by the carriage portion 3. In the present embodiment, the carriage portion 3 is detachable from the traction portion 2. For example, the vehicle transport device 1 has a known automated connection device (see, for example, Japanese Unexamined Patent Publication No. 2021-088291) for connecting and disconnecting the traction portion 2 and the carriage portion 3. The vehicle transport device 1 connects the carriage portion 3 to the traction portion 2 when the transport of the transported object is started, and releases the connection between the carriage portion 3 and the traction portion 2 when the transport of the transported object is completed.

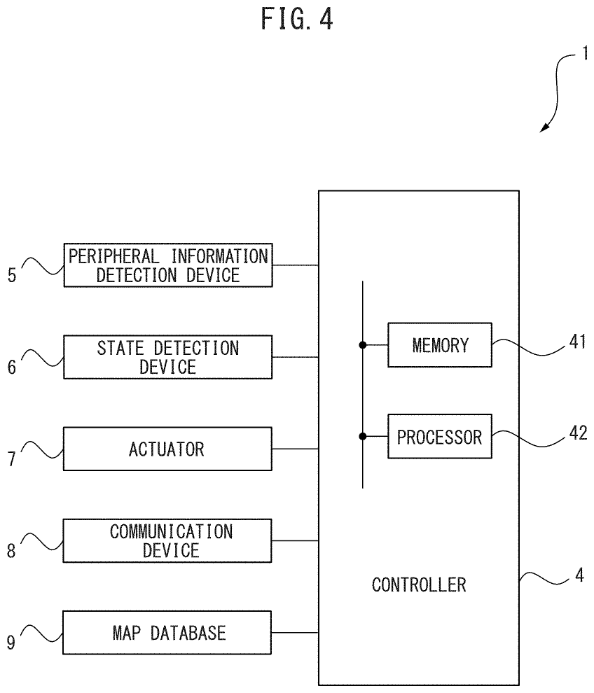

FIG. 4 is a diagram schematically showing an electric configuration of a vehicle transport device 1 according to the first embodiment of the present disclosure. As illustrated in FIG. 4, the vehicle transport device 1 includes a controller 4, a peripheral information detection device 5, a state detection device 6, an actuator 7, a communication device 8, and a map database 9. In the present embodiment, the controller 4, the peripheral information detection device 5, the state detection device 6, the actuator 7, the communication device 8, and the map database 9 are provided in the traction portion 2 of the vehicle transport device 1, and the required power is supplied to these electric components by the battery 21 through a driver, an inverter, a DC-DC converter, or the like.

The controller 4 is, for example, a general-purpose computer, performs various controls of the vehicle transport device 1. The peripheral information detection device 5, the state detection device 6, the actuator 7, the communication device 8 and the map database 9 are electrically connected to the controller 4. The controller 4 is an one example of a control device of the vehicle transport device 1.

As shown in FIG. 4, the controller 4 includes a memory 41 and a processor 42. The memory 41 and the processor 42 are connected to each other via signal lines.

The memory 41 includes, for example, a volatile semiconductor memory (e.g., RAM) and a nonvolatile semiconductor memory (e.g., ROM). The memory 41 stores computer programs executed by the processor 42, various data used when various processes are executed by the processor 42, and the like.

The processor 42 includes one or a plurality of CPUs (Central Processing Unit) and peripheral circuits thereof, and executes various processes. The processor 42 may further include an arithmetic circuit such as a logical arithmetic unit or a numerical arithmetic unit.

The peripheral information detection device 5 acquires data (images, point group data, etc.) around the vehicle transport device 1 and detects peripheral information (e.g., a transported object, an obstacle, a lane, etc.) of the vehicle transport device 1. For example, the peripheral information device 5 includes a millimeter wave radar, a camera (e.g., a stereo camera), a LIDAR: Laser Imaging Detection And Ranging, or an ultrasonic sensor (sonar), or any combinations thereof. The output of the peripheral information detection device 5, i.e., peripheral information of the vehicle transport device 1 detected by the peripheral information detection device 5, is transmitted to the controller 4.

The state detection device 6 detects the status quantity of the vehicle transport device 1. The state detection device 6 includes, for example, a Global Navigation Satellite System (GNSS) receiver for detecting the present position of the vehicle transport device 1, a speed sensor for detecting the speed of the vehicle transport device 1, a three-axis acceleration sensor for detecting the acceleration in the three axial directions of the vehicle transport device 1, and the like. The output of the status detection device 6, i.e., a state quantity of the vehicle transport device 1 detected by the status detection device 6, is transmitted to the controller 4.

The actuator 7 includes drive motors 22 that function as a drive device, a steering actuator that changes the steering angle of the drive wheels (wheels 23), an unlocking actuator that releases the connection between the traction portion 2 and the carriage portion 3, and the like. The controller 4 operates the actuator 7 based on the outputs of the peripheral information detecting device 5 and the state detecting device 6 or the like. Incidentally, the drive wheel may be an omni-directional wheel movable in all directions (e.g., a mecanum wheel, an omni wheel, etc.).

The communication device 8 allows communication between the vehicle transport device 1 and the server 90. For example, the communication device 8 is a wide area communication device accessible to the radio base station 80. The communication device 8 may be a WiFi module accessible to a WiFi router. In this case, the vehicle transport device 1 communicates with the server 90 without going through the radio base station 80.

The map database 9 stores the map information. The controller 4 acquires map information from the map database 9. Incidentally, the map database is provided outside the vehicle transport device 1 (e.g., server 90, etc.), the controller 4 may acquire the map information from the outside of the vehicle transport device 1.

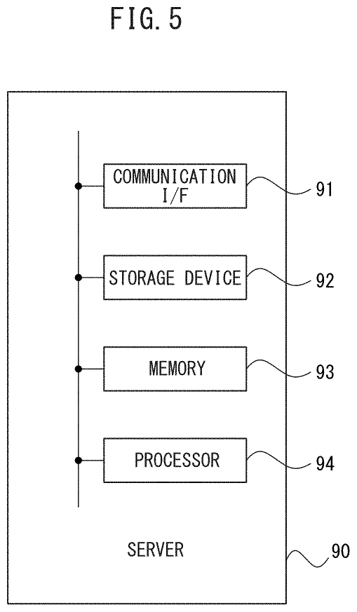

FIG. 5 is a diagram schematically showing a configuration of the server 90. The server 90 includes a communication interface 91, a storage device 92, a memory 93, and a processor 94. The communication interface 91, the storage device 92, and the memory 93 are connected to the processor 94 via signal lines. The server 90 may further include an input device such as a keyboard and a mouse, an output device such as a display, and the like. The server 90 may include a plurality of computers.

The communication interface 91 includes an interface circuit for connecting the server 90 to the communication network 81. The server 90 communicates with each of the plurality of vehicle transport devices 1 via the communication networks 81. The communication interface 91 is an example of a communication portion of the server 90.

The storage device 92 includes, for example, a hard disk drive (HDD), a solid-state drive (SDD), or an optical recording medium and its accessing device. The storage device 92 stores various data, for example, information of the vehicle transport device 1, such as identifying information and position information, and computer programs for the processor 94 to execute various processes. The storage device 92 is an example of a storage portion of the server 90.

The memory 93 includes a volatile semiconductor memory such as RAM. The memory 93 temporarily stores, for example, various data used when various processes are executed by the processor 94. The memory 93 is another example of a storage portion of the server 90.

The processor 94 includes one or a plurality of CPUs and peripheral circuits thereof, and executes various processes. It should be noted that the processor 94 may further include other arithmetic circuits, such as a logical arithmetic unit, a numerical arithmetic unit, or a graphic processing unit.

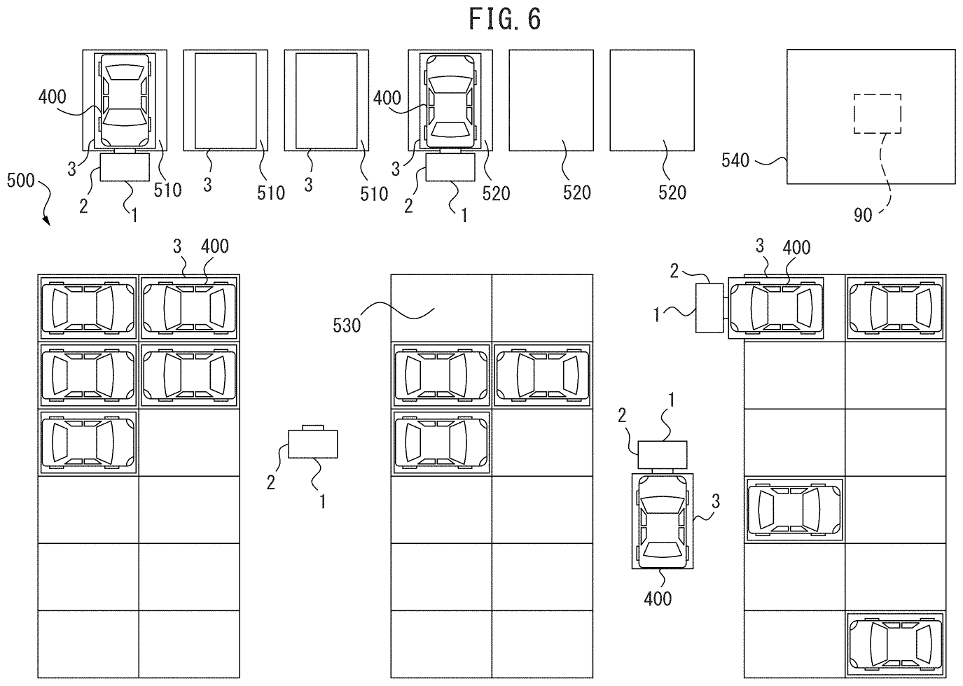

FIG. 6 is a diagram showing an example situation in which a vehicle transport service is provided. In the example of FIG. 6, the vehicle transport service is provided in the parking lot 500, and parking of a vehicle 400 is performed by the vehicle transport device 1 in place of the driver of the vehicle 400 (a four-wheeled vehicle). That is, automated valley parking is performed by the vehicle transport device 1.

In the parking lot 500, the vehicle transport is performed by a plurality of (five in the example of FIG. 6) vehicle transport devices 1. The server 90 is located, for example, in a parking control center 540 which manages the parking lot 500, and manages the plurality of vehicle transport devices 1.

The parking lot 500 is, for example, a parking lot of an airport, a station, an amusement park, a hospital, a stadium, a shopping center, or the like. The parking lot 500 has a plurality of entry spaces 510, a plurality of exit spaces 520, and a plurality of parking spaces 530. Identification numbers are assigned as identification information to the plurality of entry spaces 510, the plurality of exit spaces 520, and the plurality of parking spaces 530, respectively.

At the entry space 510, the vehicle 400 to be stored in the parking lot 500 is stopped, while at the exit space 520, the vehicle 400 to be unloaded from the parking lot 500 is stopped. The vehicle transport device 1 transports the vehicle 400 stopped in the entry space 510, and park the vehicle 400 in an empty parking space 530. On the other hand, the vehicle transport device 1 transports the vehicle 400 to be unloaded from the parking lot 500 from the parking space 530 to the exit space 520.

In the present embodiment, the carriage portion 3 of the vehicle transport device 1 is installed in advance in the entry space 510. For example, the vehicle transport device 1 releases the connection between the traction portion 2 and the carriage portion 3 in the entry space 510, and installs the carriage portion 3 in the entry space 510. The vehicle transport device 1 travels in the parking lot 500 with only the traction portion 2 when the carriage portion 3 is disconnected from the traction portion 2. Incidentally, the installation of the carriage portion 3 in the entry space 510 may be performed by an operator or the like.

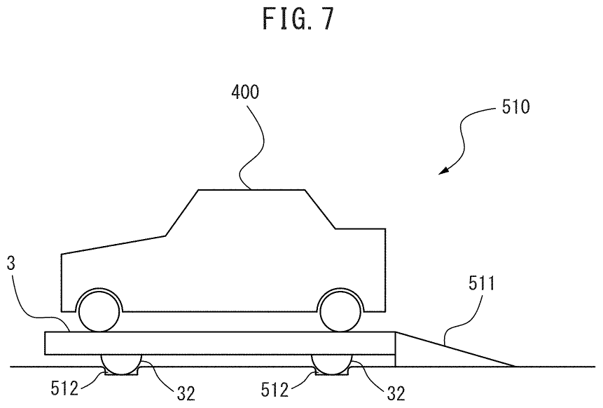

FIG. 7 is a diagram schematically illustrating a vehicle 400 supported by a carriage portion 3 of a vehicle transport device 1 in an entry space 510. For example, the vehicle 400 travels through the inclined portion 511 connected to the support surface of the carriage portion 3, and is stopped on the carriage portion 3. At the entry space 510, recesses 512 for holding the wheels 32 of the carriage portion 3 are provided, and the movement of the carriage portion 3 in the entry space 510 is restricted by the recesses 512.

The occupant of the vehicle 400, after stopping the vehicle 400 in the entry space 510, gets off the vehicle 400 in the entry space 510. Thereafter, the occupant of the vehicle 400 inputs parking request information (identification number of the entry space 510, identification information of the vehicle (information of the license plate, etc.), desired delivery time of the vehicle 400, etc.) to an information reading device (not shown) provided in the vicinity of the entry space 510. Note that the occupant of the vehicle 400 may input the parking request information to a portable terminal (smartphone, tablet terminal, or the like), and may input the parking request information to the information reading device via the short-range radio communication between the portable terminal and the information reading device, the QR code (registered trademark) displayed on the portable terminal, or the like.

When the parking request information is input to the information reading device, an entry request notification including the parking request information is transmitted from the information reading device to the server 90 via the communication network 81 or the like. Note that the information reading device may be omitted, and an entry request notification may be transmitted from the portable terminal of the occupant of the vehicle 400 to the server 90.

In response to the entry request notification, the server 90 selects one vehicle transport device 1 among the plurality of vehicle transport devices 1, and transmits a transport instruction to the vehicle transport device 1. The vehicle transport device 1 which has received the transport instruction from the server 90 moves to the entry space 510 with only the traction portion 2, and in the entry space 510, connects the carriage portion 3 on which the vehicle 400 is placed to the traction portion 2.

The vehicle transport device 1 then moves from the entry space 510 to an empty parking space 530 with the vehicle 400 on the carriage portion 3. In the present embodiment, the vehicle 400 is parked in the parking space 530 in a state of being supported by the carriage portion 3. Therefore, the vehicle transport device 1, in the parking space 530, releases the connection between the traction portion 2 and the carriage portion 3, and leaves the carriage portion 3 in the parking space 530. As a result, the unmanned parking of the vehicle 400 is completed. Also in the parking space 530, the movement of the carriage portion 3 may be restricted by a configuration such as recesses 512 of the entry space 510.

On the other hand, when the desired delivery time of the vehicle 400 which is parked in the parking lot 500 approaches, the server 90 selects one vehicle transport device 1 among the plurality of vehicle transport devices 1 in order to unload the vehicle 400 from the parking lot 500, and transmits a transport instruction to the vehicle transport device 1. The vehicle transport device 1 which has received the transport instruction from the server 90 moves to the parking space 530 with only the traction portion 2, and in the parking space 530, connects the carriage portion 3 on which the vehicle 400 is placed to the traction portion 2.

The vehicle transport device 1 then moves from the parking space 530 to an empty exit space 520 with the vehicle 400 on the carriage portion 3. Then, the vehicle transport device 1, in the exit space 520, releases the connection between the traction portion 2 and the carriage portion 3, and leaves the carriage portion 3 in the exit space 520. Thereafter, the occupant of the vehicle 400 receives the vehicle 400 in the exit space 520. The exit space 520 is configured similarly to the entry space 510, and for example, the vehicle 400 travels through the inclined portion connected to the support surface of the carriage portion 3 to exit from the exit space 520.

According to the vehicle transport service as described above, since it is not necessary to secure a space for the occupant of the vehicle to perform the boarding and alighting operation in the parking space, it is possible to provide a large number of parking spaces within a predetermined area. Further, since the troublesome work associated with the parking, such as operating a vehicle to search for a parking space and park there is not imposed on the occupant of the vehicle, it is possible to increase the convenience of the parking, and thus it is possible to promote the use of the parking.

However, vehicles to be transported do not always exist in the area to which the vehicle transport device 1 is dispatched. Therefore, the waiting time of the vehicle transport device 1 is increased, and there is a possibility that the vehicle transport device 1 cannot be effectively utilized. On the other hand, in a predetermined target area where the automatic valley parking using the vehicle-transport device 1 is performed, it is assumed that the sharing of a plurality of personal transporters is performed in order to assist the movement of the residents.

A personal transporter is defined, for example, as a one- or two-passenger small mobile device, and is used as a mobile means for short distance movement in a target area such as a smart city. In the sharing of the personal transporters, a plurality of boarding places are prepared in a target area, and lending and returning of the personal transporter are performed in each of the plurality of boarding places. A user of the personal transporter receives the personal transporter at a desired boarding place and returns the personal transporter at the same or another boarding place as the departure point.

If the lending and returning of the personal transporter are intensively performed in a specific boarding place, there is a possibility that the inventory of the personal transporters in the boarding place is unbalanced and it causes inconvenience to the user. Therefore, it is desirable to move the personal transporter from a boarding place where there is a large inventory of personal transporter to a boarding place where there is a small inventory of personal transporter.

Therefore, in the present embodiment, using the vehicle transport device 1, not only the transport of a four-wheeled vehicle in the parking lot or the like, but also the transport of personal transporter are performed. Therefore, the carriage portion 3 of the vehicle transport device 1 has a support plate 31 configured to support both the four-wheeled vehicle and the personal transporter, and the controller 4 of the vehicle transport device 1 controls the travel of the vehicle transport device 1 so as to selectively transport the four-wheeled vehicle and the personal transporter as the transport object. Thus, it is possible to suppress the waiting time of the vehicle transport device 1 from being increased, and thus it is possible to increase the operation rate of the vehicle transport device 1.

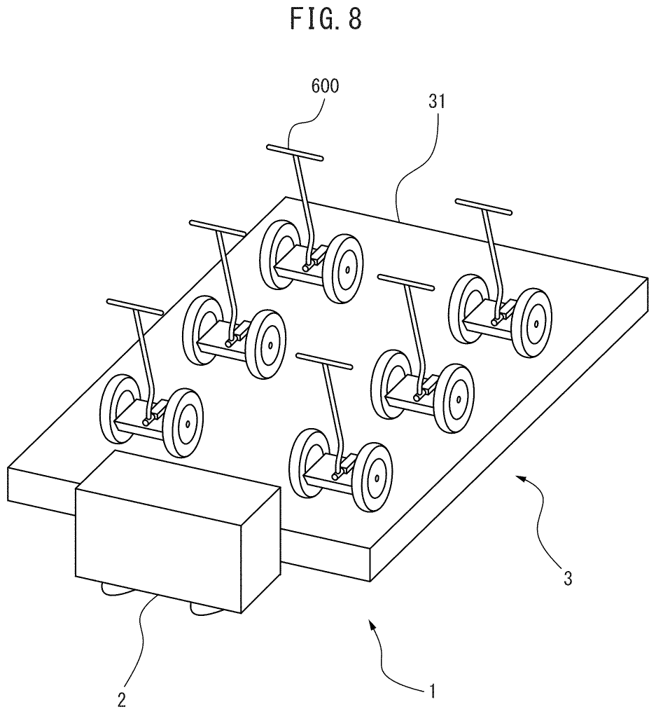

FIG. 8 is a diagram schematically illustrating a vehicle transport device 1 transporting the personal transporters 600. As shown in FIG. 8, each personal transporter 600 rests on a flat support surface of support plate 31, and vehicle transport device 1 can carry a plurality of personal transporters 600 at the same time. For example, the carriage portion 3 is pre-installed in a plurality of boarding places. If predetermined stopping spaces are occupied when a user of a personal transporter 600 returns the personal transporter 600 at the boarding place, the user stops the personal transporter 600 on the carriage portion 3 installed at the boarding place.

Further, in the present embodiment, the vehicle transport device 1 prioritizes the transport of the four-wheeled vehicle over the transport of the personal transporter. For example, the controller 4 of the vehicle transport device 1 controls the travel of the vehicle transport device 1 so that the vehicle transport device 1 transports the four-wheeled vehicle when the transport of the four-wheeled vehicle is requested, and controls the travel of the vehicle transport device 1 so that the vehicle transport device 1 transports the personal transporter when the transport of the four-wheeled vehicle is not requested. This makes it possible to effectively utilize the vehicle transport device 1 while avoiding the influence on the transport of the four-wheeled vehicle, which is the original function of the vehicle transport device 1.

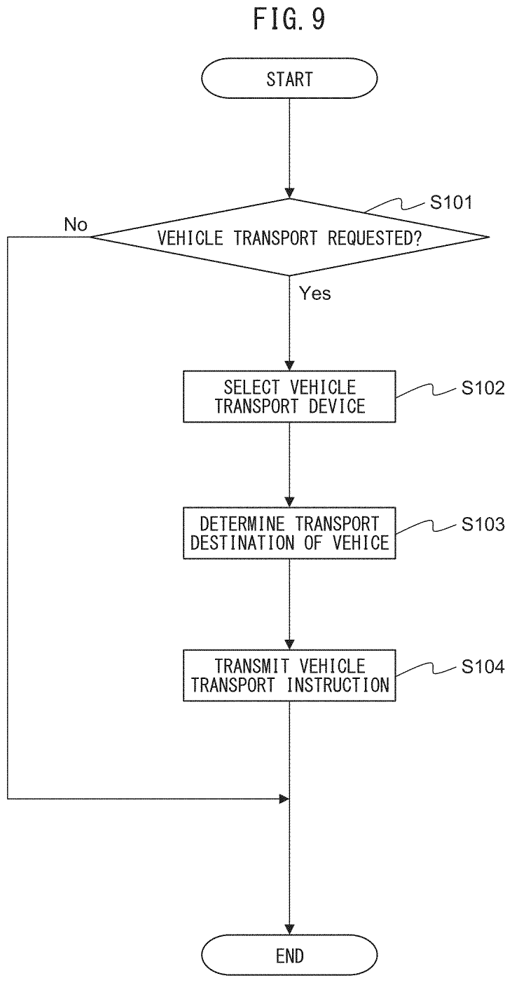

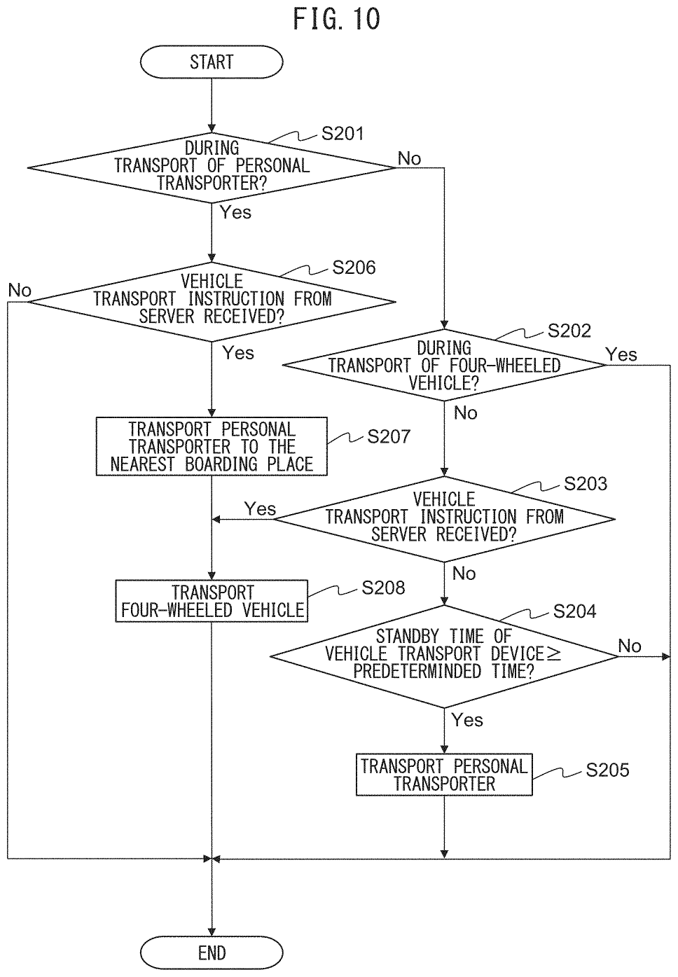

Hereinafter, referring to FIGS. 9 and 10, the control flow will be described in detail when the vehicle transport device 1 selectively transports the four-wheeled vehicle and the personal transporter. FIG. 9 is a flowchart illustrating a control routine executed in the server 90. The control routine is executed by the processor 94 of the server 90 in accordance with a computer program stored in the memory 93 of the server 90.

Initially, at step S101, the processor 94 determines whether vehicle transport has been requested. For example, the processor 94 determines that the vehicle transport is requested when an entry request notification is transmitted from the information reading device to the server 90, or when the time from the present time to the desired delivery time of the parked vehicle reaches a predetermined time. If it is determined in step S101 that the vehicle transport is not requested, the control routine ends. On the other hand, if it is determined in step S101 that the vehicle transport is requested, the control routine proceeds to step S102.

In the step S102, the processor 94 selects one vehicle transport device 1 from a plurality of vehicle transport devices 1. At this time, based on the previous entry and exit information or the like, a vehicle transport device 1 that is not transporting a four-wheeled vehicle, i.e., a vehicle transport device 1 in the standby state, is selected.

Next, in step S103, the processor 94 determines the destination of the four-wheeled vehicle.

If the four-wheeled vehicle is to be transported for exit, the processor 94 selects an empty exit space 520 as the destination for the four-wheeled vehicle. Whether or not the exit space 520 is empty is determined based on, for example, past entry and exit information. Incidentally, this determination may be performed based on the output of a vehicle detection device such as a metal detector or a camera provided in the exit space 520.

On the other hand, if the four-wheeled vehicle is transported for entry, the processor 94 selects an empty parking space 530 as the transport destination of the four-wheeled vehicle. Whether or not the parking space 530 is empty is determined based on, for example, past entry and exit information. Incidentally, this determination may be performed based on the output of a vehicle detection device such as a metal detector or a camera provided in the parking space 530.

Then, in step S104, the processor 94 transmits a vehicle transport instruction to the vehicle transport device 1 selected in step S102. The vehicle transport instruction includes the current position of the four-wheeled vehicle to be transported (for example, the identification number of the entry space 510 or the parking space 530), information on the transport destination (for example, the identification number of the parking space 530 or the exit space 520), and the like. After step S104, the control routine ends.

On the other hand, the vehicle transport device 1 selectively transports a four-wheeled vehicle and a personal transporter in response to an instruction from the server 90. FIG. 10 is a flow chart showing the control routines executed in the vehicle transport device 1. The control routine is executed by the processor 42 of the controller 4 in accordance with a computer program stored in the memory 41 of the controller 4.

First, in a step S201, the processor 42 determines whether or not the vehicle transport device 1 is transporting a personal transporter, i.e., whether or not a personal transporter is placed on the carriage portion 3. Whether or not the vehicle transport device 1 is transporting a personal transporter is determined based on, for example, the previous transport history of the vehicle transport device 1. Incidentally, this determination may be performed based on the output of the peripheral information detection device 5 provided in the vehicle transport device 1.

If it is determined in step S201 that the vehicle transport device 1 is not transporting a personal transporter, the control routine proceeds to step S202. In step S202, the processor 42 determines whether or not the vehicle transport device 1 is transporting a four-wheeled vehicle, i.e., whether the four-wheeled vehicle is placed on the carriage portion 3. Whether the vehicle transport device 1 is transporting a four-wheeled vehicle is determined based on, for example, the previous transport history of the vehicle transport device 1. Incidentally, this determination may be performed based on the output of the peripheral information detection device 5 provided in the vehicle transport device 1.

If it is determined that the vehicle transport device 1 is transporting a four-wheeled vehicle in the step S202, the control routine ends. In this case, the transport of the four-wheeled vehicle by the vehicle transport device 1 is continued. On the other hand, if it is determined that the vehicle transport device 1 is not transporting a four-wheeled vehicle in the step S202, the control routine proceeds to step S203.

In step S203, the processor 42 determines whether a vehicle transport instruction has been received from the server 90. When it is determined that the vehicle transport instruction has been received from the server 90, the control routine proceeds to step S208.

In the step S208, the processor 42 controls the travel of the vehicle transport device 1 so that the vehicle transport device 1 transports the four-wheeled vehicle on the basis of the vehicle transport instruction from the server 90.

On the other hand, if it is determined in step S203 that the vehicle transport instruction has not been received from the server 90, the control routine proceeds to step S204.

In step S204, the processor 42 determines whether or not the standby time of the vehicle transport device 1 is equal to or longer than a predetermined time, that is, whether or not the elapsed time from the completion of the transport of the four-wheeled vehicle by the vehicle transport device 1 is equal to or longer than a predetermined time. The predetermined time is set to, for example, 5 to 30 minutes.

If it is determined in step S204 that the standby time of the vehicle transport device 1 is less than the predetermined time, the control routine ends. In this case, the vehicle transport device 1 remains in the standby status. On the other hand, when it is determined that the standby time of the vehicle transport device 1 is equal to or longer than the predetermined time in the step S204, the control routine proceeds to step S205.

In the step S205, the processor 42 controls the travel of the vehicle transport device 1 so that the vehicle transport device 1 transports personal transporter. For example, in accordance with the control of the processor 42, the vehicle transport device 1 moves to a predetermined boarding place, and if the number of personal transporter on the carriage portion 3 installed at the boarding place is equal to or greater than a predetermined value, transports the carriage portion 3 together with the personal transporter to another boarding place. After the step S205, this control routine ends.

On the other hand, if it is determined in the step S201 that the vehicle transport device 1 is transporting the personal transporter, the control routine proceeds to step S206. In step S206, the processor 42 determines whether a vehicle transport instruction has been received from the server 90.

If it is determined in step S206 that the vehicle transport instruction has not been received from the server 90, the control routine ends. In this case, the transport of personal transporter by the vehicle transport device 1 is continued. On the other hand, if it is determined in step S206 that the vehicle transport instruction has been received from the server 90, the control routine proceeds to step S207.

In the step S207, the processor 42 controls the travel of the vehicle transport device 1 so that the vehicle transport device 1 transports personal transporter to the nearest boarding place.

Then, in the step S208, the processor 42 controls the travel of the vehicle transport device 1 so that the vehicle transport device 1 transports the four-wheeled vehicle based on the vehicle transport instruction from the server 90. That is, in accordance with the control of the processor 42, the vehicle transport device 1 returns to the transport location of the four-wheeled vehicle (e.g., a predetermined parking lot), and resumes the transport of the four-wheeled vehicle. After step S208, the control routine ends.

### Second Embodiment

The vehicle transport system and the vehicle transport device according to the second embodiment are basically the same as the vehicle transport system and the vehicle transport device according to the first embodiment, except for the following points. Therefore, the second embodiment of the present disclosure will be described below focusing on portions different from the first embodiment.

In the first embodiment, selective transport of a four-wheeled vehicle and a personal transporter is implemented by using a support plate 31 of the carriage portion 3 which is configured to support both a four-wheeled vehicle and a personal transporter. On the other hand, in the second embodiment, the carriage portion of the vehicle transport device includes a first carriage portion configured to support a four-wheeled vehicle and a second carriage portion configured to support a personal transporter. The traction portion of the vehicle transport device has the same configuration as that of the first embodiment, and is selectively coupled to the first carriage portion and the second carriage portion.

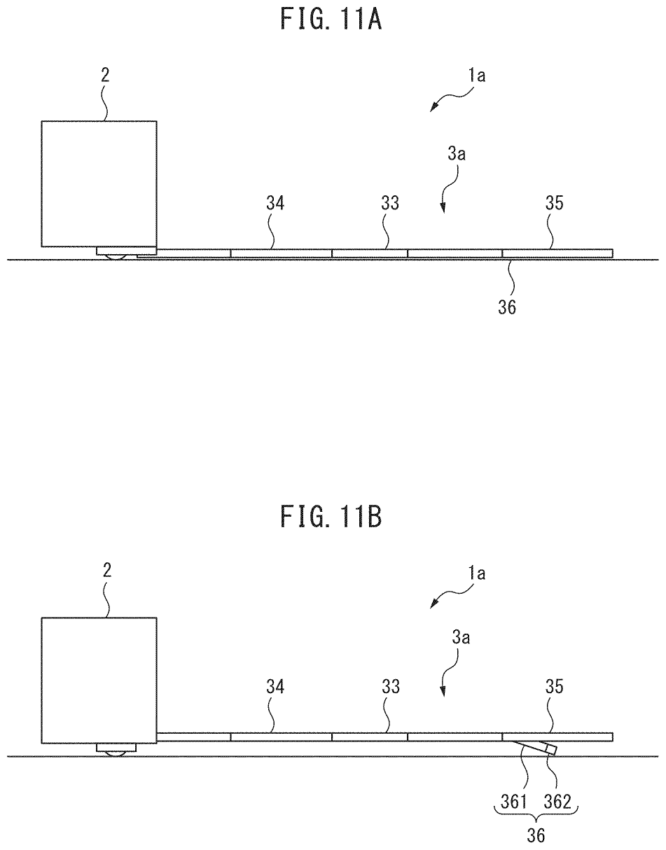

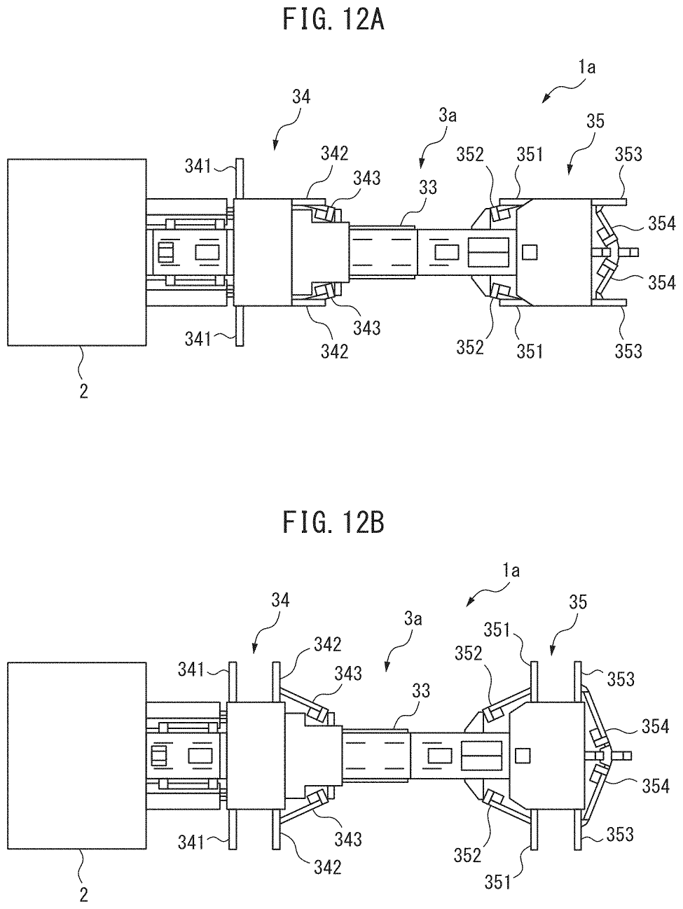

First, a first carriage portion 3a configured to support a four-wheeled vehicle will be described. FIGS. 11A and 11B are side views of the vehicle transport device 1a having a first carriage portion 3a, FIGS. 12A and 12B are top views of the vehicle transport device 1a having the first carriage portion 3a. In the FIGS. 11A and 12A, the vehicle transport device 1a in a state of not supporting a four-wheeled vehicle is shown, while in the FIGS. 11B and 12B, the vehicle transport device 1a in a state of supporting a four-wheeled vehicle is shown. The first carriage portion 3a extends into the space between the lower part portion of the four-wheeled vehicle and the road surface from the front or rear of the four-wheeled vehicle, and supports the four-wheeled vehicle by lifting the four tires of the four-wheeled vehicle.

As shown in FIG. 11A to FIG. 12B, the first carriage part 3a has a telescopic arm 33, a front support portion 34, a rear support portion 35, and a lift portion 36. The telescopic arm 33 extends from the traction portion 2, and the front support portion 34, the rear support portion 35 and the lift portion 36 is attached to the telescopic arm 33. The front support portion 34 and the rear support portion 35 are spaced apart in the extending direction of the telescopic arm 33 (longitudinal direction), and the lift portion 36 is disposed at the same position as the rear support portion 35 in the extending direction of the telescopic arm 33. The front support portion 34 supports one tire of the front tire and the rear tire of the four-wheeled vehicle to be transported, and the rear support 35 supports the other tire of the front tire and the rear tire of the four-wheeled vehicle to be transported.

The telescopic arm 33 contributes to the strength of the carriage portion 3, and adjusts the distance between the front support portion 34 and the rear support portion 35. For example, the telescopic arm 33 is driven by a linear actuator (not shown) and is extendable and retractable such that the distance between the front support portion 34 and the rear support portion 35 varies. The telescopic arm 33 is extended and contracted between a retracted position where the distance between the front support portion 34 and the rear support portion 35 is the shortest, and an extended position where the distance between the front support portion 34 and the rear support portion 35 is the longest.

The front support portion 34 has a pair of fixing clamp arms 341, a pair of first movable clamp arms 342, and a pair of first linear actuators 343. The pair of fixing clamp arms 341 and a pair of first movable clamp arms 342 are spaced apart in the extending direction of the telescopic arm 33. The pair of fixing clamp arms 341 are disposed closer to the traction portion 2 than the pair of first movable clamp arms 342, and extend perpendicularly to the telescopic arm 33. On the other hand, the pair of first movable clamp arms 342 are coupled to the pair of first linear actuators 343 and are rotated by the reciprocating motion of the pair of first linear actuators 343. In the present embodiment, the pair of first movable clamp arms 342 are rotated 90 degrees between the closed position parallel to the telescopic arm 33 (FIG. 12A) and the open position perpendicular to the telescopic arm 33 (FIG. 12B).

The rear support portion 35 includes a pair of second movable clamp arms 351, a pair of second linear actuators 352, a pair of third movable clamp arms 353, and a pair of third linear actuators 354. The pair of second movable clamp arms 351 and the pair of third movable clamp arms 353 are spaced apart in the extending direction of the telescopic arm 33. The pair of second movable clamp arms 351 are coupled to the pair of second linear actuators 352 and are rotated by reciprocating motion of the pair of second linear actuators 352. In the present embodiment, the pair of second movable clamp arms 351 are rotated 90 degrees between the closed position parallel to the telescopic arm 33 (FIG. 12A) and the open position perpendicular to the telescopic arm 33 (FIG. 12B). On the other hand, the pair of third movable clamp arms 353 are coupled to the pair of third linear actuators 354 and are rotated by the reciprocating motion of the pair of third linear actuators 354. In the present embodiment, the pair of third movable clamp arms 353 are rotated 90 degrees between the closed position parallel to the telescopic arm 33 (FIG. 12A) and the open position perpendicular to the telescopic arm 33 (FIG. 12B).

The lift portion 36 has a pivot arm 361 and four rear tires 362 attached to the distal end of the pivot arm 361. The pivot arm 361 is driven by, for example, a lifting motor (not shown) and rotates relative to the telescopic arm 33 in a state where the rear tires 362 are in contact with the road surface. The pivot arm 361 rotates between a stationary position parallel to the telescopic arm 33 (FIG. 11A), and the lift position obliquely with respect to the telescopic arm 33 (FIG. 11B) so as to change the distance between the telescopic arm 33 and the road surface.

The vehicle transport device 1a, when not supporting a four-wheeled vehicle, becomes the state shown in FIG. 11A and FIG. 12A. That is, the telescopic arm 33 is positioned in the retracted position, the first movable clamp arms 342, the second movable clamp arms 351 and the third movable clamp arms 353 are positioned in the closed position, and the pivot arm 361 is positioned in a stationary position. On the other hand, the vehicle transport device 1a, when supporting a four-wheeled vehicle, becomes a state shown in FIG. 11B and FIG. 12B. That is, the telescopic arm 33 is positioned in the extended position, the first movable clamp arms 342, the second movable clamp arms 351 and the third movable clamp arms 353 are positioned in the open position, and the pivot arm 361 is positioned in the lift position.

Hereinafter, the operation of the vehicle transport device 1a when the vehicle transport device 1a transports a vehicle (a four-wheeled vehicle) will be described. First, the vehicle transport device 1a approaches the vehicle so that the first carriage portion 3a is inserted between the vehicle and the road surface through the space between the left and right front tires from the front of the vehicle. At this time, the vehicle transport device 1a moves relative to the vehicle so that the telescopic arm 33 is positioned on the vehicle width centerline. When the rear support portion 35 passes beyond the front tires and is positioned between the front tires and the rear tires, the second movable clamp arms 351 of the rear support portion 35 are rotated from the closed position to the open position. Then, the vehicle transport device 1a is moved rearward of the vehicle until the fixing clamp arms 341 of the front support portion 34 are in contact with the front tires of the vehicle.

When the fixing clamp arms 341 abut the front tires of the vehicle, the telescopic arm 33 is extended until the second movable clamp arms 351 in the open position abut the rear tires of the vehicle. Thereafter, in a state where the fixing clamp arms 341 are in contact with the front tires of the vehicle and the second movable clamp arms 351 are in contact with the rear tires of the vehicle, the first movable clamp arms 342 of the front support portion 34 and the third movable clamp arms 353 of the rear support portion 35 are rotated from the closed position to the open position. As a result, the front tires of the vehicle are clamped by the fixing clamp arms 341 and the first movable clamp arms 342, while the rear tires of the vehicle are clamped by the second movable clamp arms 351 and the third movable clamp arms 353.

With all tires of the vehicle clamped, the pivot arm 361 of the lift portion 36 is rotated from a stationary position to a lift position. As a result, the tires of the vehicle are separated from the road surface, and the vehicle is supported by the first carriage portion 3a. The vehicle transport device 1a moves to the target position (e.g., parking space) by autonomous running with the first carriage portion 3a supporting the vehicle. At the target position, the vehicle is unloaded from the vehicle transport device 1a in the opposite manner to that described above.

In the above description, although the first carriage portion 3a is inserted below the vehicle from the front of the vehicle, the first carriage portion 3a may be inserted below the vehicle from the rear of the vehicle. In this case, the rear tires of the vehicle are clamped by the fixing clamp arms 341 and the first movable clamp arms 342, while the front tires of the vehicle are clamped by the second movable clamp arms 351 and the third movable clamp arms 353.

As described above, in the second embodiment, the vehicle transport device 1a can automatically unload the vehicle from the first carriage portion 3a. Therefore, since it is not necessary to leave the carriage portion together with the vehicle in the parking space, it is possible to reduce the number of carriage portions necessary to provide a vehicle transport service. Further, by transporting the vehicle in a state in which the tires of the vehicle are clamped and lifted, more stable vehicle transport is possible.

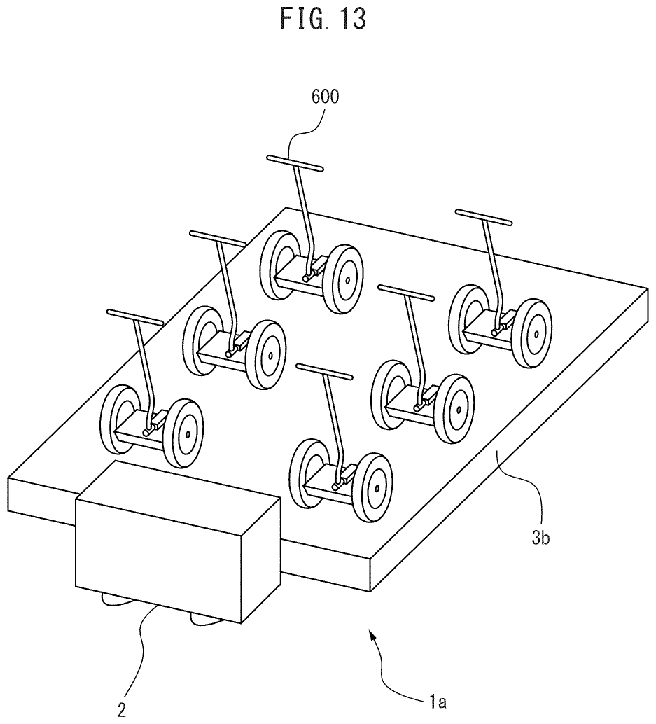

FIG. 13 is a diagram schematically illustrating a vehicle transport device 1a having a second carriage portion 3b. The second carriage portion 3b has the same configuration as the carriage portion 3 in the first embodiment, and can support a plurality of personal transporters 600. For example, the second carriage portion 3b is pre-installed in a plurality of boarding places of the personal transporter 600. A user of a personal transporter 600 stops the personal transporter 600 on the second carriage portion 3b installed in the boarding place when a predetermined stopping space is occupied when returning the personal transporter 600 in the boarding place.

Vehicle transport device 1a , as in the first embodiment, has an automatic coupling device for connecting and disconnecting the traction portion 2 and the carriage portion (the first carriage portion 3a or the second carriage portion 3b). The vehicle transport device 1a connects the first carriage portion 3a to the traction portion 2 when transporting a four-wheeled vehicle, and connects the second carriage portion 3b to the traction portion 2 when transporting a personal transporter.

In the second embodiment, similarly to the first embodiment, the control routine of FIG. 9 is executed in the server 90, and the control routine of FIG. 10 is executed in the vehicle transport device 1a. In the step S205 of FIG. 10, when the vehicle transport device 1a starts transporting the personal transporter, for example, the vehicle transport device 1a leaves the first carriage portion 3a at a predetermined location in the parking lot and moves to the boarding place of the personal transporter with only the traction portion 2. Thereafter, when the transport of the four-wheeled vehicle is restarted, the vehicle transport device 1a connects the left first carriage portion 3a to the traction portion 2.

Note that, in the second embodiment, the coupling and disconnection of the traction portion 2 and the carriage portion (the first carriage portion 3a or the second carriage portion 3b) may be performed by an operator in a parking lot where the transport of the four-wheeled vehicle is performed or the like.

### Third Embodiment

The vehicle transport system and vehicle transport device according to the third embodiment are basically the same as the vehicle transport system and vehicle transport device according to the first embodiment, except for the following points. Therefore, the third embodiment of the present disclosure will be described below focusing on portions different from the first embodiment.

In the first embodiment, selective transport of a four-wheeled vehicle and a personal transporter is implemented by using a support plate 31 of the carriage portion 3 which is capable of supporting both a four-wheeled vehicle and a personal transporter. On the other hand, in the third embodiment, the carriage portion of the vehicle transport device includes a vehicle support portion configured to support the four-wheeled vehicle, and a detachable portion that is detachable from the vehicle support portion and is configured to support the personal transporter.

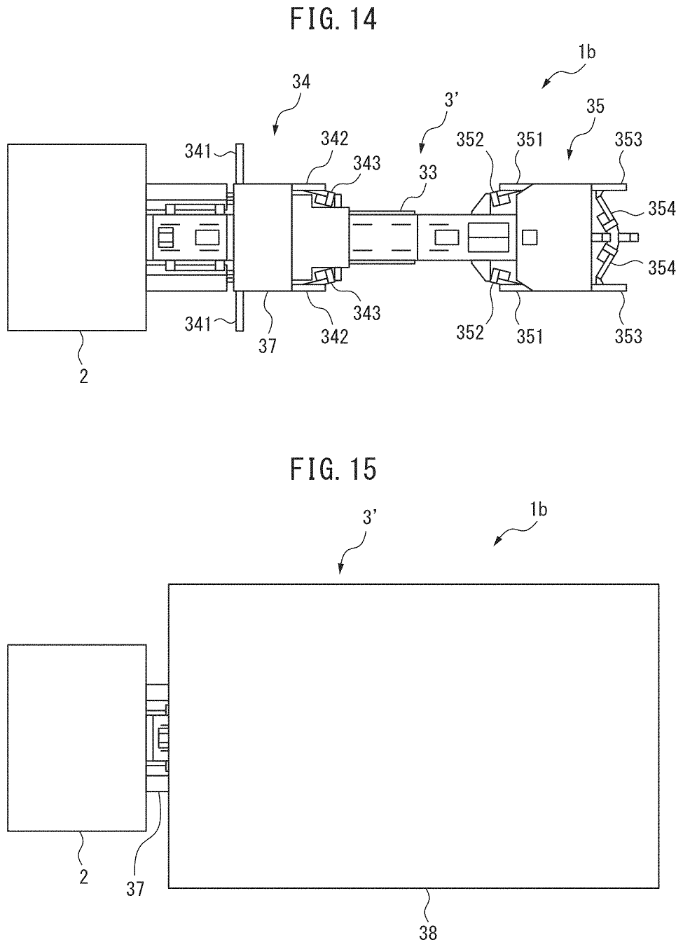

FIG. 14 is a top view of a vehicle transport device 1b in which the detachable portion is removed, and FIG. 15 is a top view of the vehicle transport device 1b in which the detachable portion 38 is attached. The vehicle transport device 1b, as in the first embodiment, has a traction portion 2 and a carriage portion 3′. As shown in FIG. 14, the carriage portion 3′ has a vehicle support portion 37 coupled to the traction portion 2.

The vehicle support portion 37 has the same configuration as the first carriage portion 3a of the second embodiment, and is configured to support a four-wheeled vehicle. That is, the vehicle support portion 37 includes a telescopic arm 33, a front support portion 34, a rear support portion 35, and a lift portion 36. The vehicle support 37 extends into the space between the lower part portion of the four-wheeled vehicle and the road surface from the front or rear of the four-wheeled vehicle, and supports the four-wheeled vehicle by lifting the four tires of the four-wheeled vehicle.

Further, as shown in FIG. 15, the carriage portion 3′ has a detachable portion 38 detachable from the vehicle support portion 37. The detachable portion 38 is attached to the vehicle support portion 37 so as to cover the upper portion of the vehicle support portion 37. For example, the vehicle transport device 1b integrates the vehicle support portion 37 and the detachable portion 38 by slipping the vehicle support portion 37 under the detachable portion 38 and lifting the detachable portion 38 by the lift portion 36 of the vehicle support portion 37.

The vehicle transport device 1b removes the detachable portion 38 from the vehicle support portion 37 when transporting a four-wheeled vehicle, and attaches the detachable portion 38 to the vehicle support portion 37 when transporting a personal transporter. The carriage portion 3′ in which the detachable portion 38 is attached to the vehicle support portion 37 has the same configuration as the carriage portion 3 in the first embodiment, and can support a plurality of personal transporters. For example, the detachable portion 38 is installed in advance in a plurality of boarding places of the personal transporter. When returning the personal transporter 600 at the boarding place, the user of the personal transporter 600 stops the personal transporter 600 on the detachable portion 38 installed at the boarding place when a predetermined stop space is occupied.

In the third embodiment, as in the first embodiment, the control routine of FIG. 9 is executed in the server 90, and the control routine of FIG. 10 is executed in the vehicle transport device 1b. When the vehicle transport device 1b transports a personal transporter in the step S205 of FIG. 10, for example, the vehicle transport device 1b attaches the detachable portion 38 on which the personal transporter is placed to the vehicle support portion 37 at the boarding place of the personal transporter.

Note that in the third embodiment, attaching the detachable portion 38 to the vehicle support portion 37, and removing the detachable portion 38 from the vehicle support portion 37 may be performed by an operator.

### Fourth Embodiment

The vehicle transport system and vehicle transport device according to the fourth embodiment are basically the same as the vehicle transport system and vehicle transport device according to the first embodiment, except for the following points. Therefore, the fourth embodiment of the present disclosure will be described below focusing on portions different from the first embodiment.

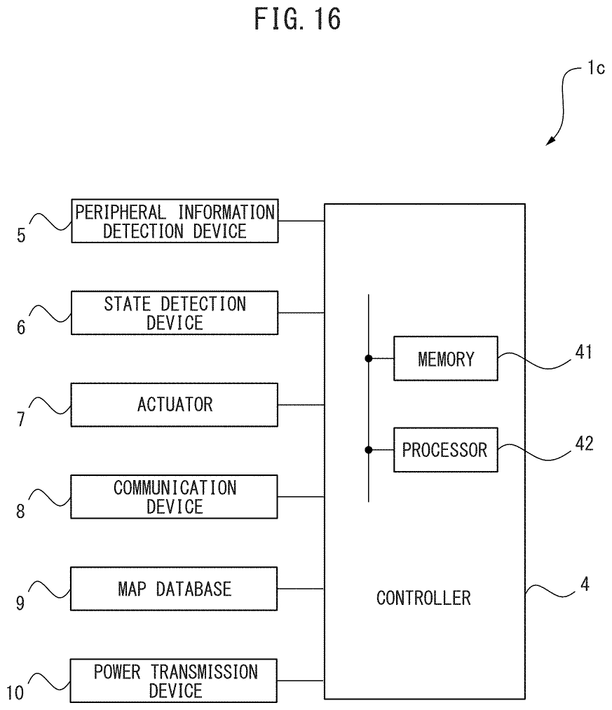

FIG. 16 is a diagram schematically showing an electric configuration of a vehicle transport device 1c according to a fourth embodiment of the present disclosure. As shown in FIG. 16, in the fourth embodiment, the vehicle transport device 1c has a power transmission device 10, in addition to the controller 4, the peripheral information detection device 5, the state detection device 6, the actuator 7, the communication device 8 and the map database 9.

The power transmission device 10 is provided in the carriage portion 3 and supplies power to the personal transporter supported by the carriage portion 3. For example, the power transmission device 10 has a plurality of power transmission coils, and power from the battery 21 of the traction unit 2 is supplied via an inverter or the like to each of the plurality of power transmission coils. Each of the plurality of power transmission coils provides power to a power receiving coil provided in personal transporter in a non-contact manner. Consequently, power is transferred from the battery 21 of the vehicle transport device 1c to a battery of the personal transporter.

The controller 4 of the vehicle transport device 1c provides power to the personal transporter from the power transmission device 10 when the vehicle transport device 1c is transporting the personal transporter. By this, the personal transporter can be charged during the transport of the personal transporter, and the transportation time can be effectively utilized.

Incidentally, the power transmission device 10 may be an electric connector or the like connected to the charging cable of the personal transporter. In this case, power is then transferred from the battery 21 of the vehicle transport device 1c to a battery of the personal transporter via an electric connector.

### Other Embodiments

While preferred embodiments of the present disclosure have been described above, the present disclosure is not limited to these embodiments, and various modifications and changes may be made within the scope of the appended claims.

For example, so long as the vehicle transport device is configured to transport both a four-wheeled vehicle and a personal transporter, the specific configuration of the vehicle transport device is not limited to that described above. Further, the vehicle transport device may transport a four-wheeled vehicle from any location within the target area based on a request of the user or the like.

In addition, when discarding of personal transporter is permitted in a place other than the boarding place (for example, a road dedicated to personal transporter or a road dedicated to personal transporter and pedestrians), the vehicle transport device may collect the discarded personal transporter and transport the personal transporter to the boarding place. In such cases, accommodating the personal transporter in the carriage portion of the vehicle transport device is carried out, for example, by remote control of personal transporter by short-range radio communication between the vehicle transport device and personal transporter, manual work by a worker, etc.

In addition, the above-described embodiments can be optionally combined and implemented. For example, when the second embodiment and the fourth embodiment are combined, the power transmission device 10 is provided in the second carriage portion 3b, and when the third embodiment and the fourth embodiment are combined, the power transmission device 10 is provided in the vehicle support portion 37 or the detachable portion 38 of the carriage portion 3′.

### DESCRIPTION OF SYMBOLS

1, 1a, 1b, 1c Vehicle transport device
2 Traction portion
23 Wheels (drive wheels)
3, 3′ Carriage portion
3a First carriage portion
3b Second carriage portion
4 Controller
42 Processor
90 Server
94 Processor
100 Vehicle transport system
400 Four-wheeled vehicle
600 Personal transporter

1. A vehicle transport device, comprising:
a traction portion having a drive wheel;
a carriage portion coupled to the traction portion and supporting a transport object; and
a controller configured to control travel of the vehicle transport device so as to selectively transport a four-wheeled vehicle and a personal transporter as the transport object.

2. The vehicle transport device according to claim 1, wherein the carriage portion has a support plate configured to support a four-wheeled vehicle and a personal transporter.

3. The vehicle transport device according to claim 1, wherein
the carriage portion includes a first carriage portion configured to support a four-wheeled vehicle and a second carriage portion configured to support a personal transporter, and
the traction portion is selectively coupled to the first carriage portion and the second carriage portion.

4. The vehicle transport device according to claim 1, wherein the carriage portion has a vehicle support portion configured to support a four-wheeled vehicle, and a detachable portion that is detachable from the vehicle support portion and is configured to support a personal transporter.

5. The vehicle transport device according to claim 1, wherein the controller is configured to control travel of the vehicle transport device so that the vehicle transport device transports a four-wheeled vehicle when transport of a four-wheeled vehicle is requested, and control travel of the vehicle transport device so that the vehicle transport device transports a personal transporter when transport of a four-wheeled vehicle is not requested.

6. The vehicle transport device according to claim 1, wherein
a power transmission device for supplying power to a personal transporter is provided in the carriage portion, and
the controller is configured to supply power to the personal transporter from the power transmission device when the vehicle transport device is transporting the personal transporter.

7. A vehicle transport method, comprising selectively transporting a four-wheeled vehicle and a personal transporter using a self-propelled vehicle transport device.

8. A vehicle transport system, comprising:
a server; and
a plurality of vehicle transport devices configured to communicate with the server, wherein
each of the plurality of vehicle transport devices is configured to selectively transport a four-wheeled vehicle and a personal transporter in response an instruction from the server.
